(19) United States
(12) Patent Application Publication
(10) Pub. No.: US 2020/0124771 A1
(43) Pub. Date: Apr. 23, 2020

(54) PANE HAVING AN ELECTRICALLY CONDUCTIVE COATING, WITH REDUCED VISIBILITY OF FINGERPRINTS

(71) Applicant: SAINT-GOBAIN GLASS FRANCE, COURBEVOIE (FR)

(72) Inventors: Jan HAGEN, Bonn (DE); Julian LINGNER, Herzogenrath (DE); Julie RUFF, Aachen (DE); Robert BESLER, Herzogenrath (DE); Florian MANZ, Aachen (DE)

(21) Appl. No.: 16/612,520

(22) PCT Filed: Apr. 16, 2018
(86) PCT No.: PCT/EP2018/059658

§ 371 Date: Nov. 11, 2019

(30) Foreign Application Priority Data
May 9, 2017 (EP) 17170130.3

(51) Int. Cl. G02B 1/116; C03C 17/23; C03C 17/36; C03C 17/34

(52) U.S. Cl. CPC G02B 1/116; C03C 17/23; C03C 17/3655; C03C 2217/24; C03C 17/3435; C03C 17/3626; C03C 2217/948; C03C 17/3417

(57) ABSTRACT

A pane having an electrically conductive coating, includes a substrate and an electrically conductive coating on an exposed surface of the substrate, which coating includes at least one electrically conductive layer, wherein the pane has a local minimum of reflectance (RL) in the range from 310 nm to 360 nm and a local maximum of reflectance (RL) in the range from 400 nm to 460 nm.

The invention relates to a pane having an electrically conductive coating, as well as production and use thereof.

Glass panes with transparent electrically conductive coatings are known. The glass panes can thus be provided with a function without substantially disrupting through-vision through the pane. Such coatings are used, for example, as heatable coatings or thermal radiation reflecting coatings on window panes for vehicles or buildings.

The interior of a motor vehicle or of a building can heat up greatly during the summer with high ambient temperatures and intense direct sunlight. In contrast, when the outside temperature is lower than the temperature in the interior, which occurs in particular in the winter, a cool pane acts as a heat sink, which is perceived as unpleasant. Also, the interior must be heated strongly in order to avoid cooling via the window panes.

Thermal radiation reflecting coatings (so-called “low-E coatings”) reflect a significant part of sunlight, in particular in the infrared range, which, in the summer, results in reduced warming of the interior. Moreover, the coating reduces the emission of longwave thermal radiation into the interior. With low outside temperatures in winter, it also reduces the outward emission of heat from the interior into the external surroundings.

For optimum effect, the thermal radiation reflecting coating must be arranged on the exposed interior-side surface of the pane, i.e., so to speak, between the interior and the actual glass pane. There, the coating is exposed to the atmosphere, ruling out the use of corrosion prone coatings based, for example, on silver. Due to their corrosion resistance and good conductivity, coatings based on transparent conductive oxides (TCO), for example, indium tin oxide (ITO) have proved themselves as electrically conductive coatings on exposed surfaces. Such coatings are known, for example, from EP 2 141 135 A1, WO 2010115558 A1, and WO 2011105991 A1.

Coatings on exposed surfaces have the disadvantage that they can be touched by individuals, possibly leaving fingerprints. The fingerprints are often particularly readily visible on the coatings, which can greatly reduce the aesthetic effect of the pane or result in disturbing local changes in light reflection. Fingerprints are sometimes difficult to remove with customary cleaning agents, with the additional necessity of being careful not to damage the coating with chemicals or strong mechanical stress during cleaning.

Known approaches for reducing the visibility of fingerprints include the use of roughened surfaces or hydrophobic and oleophobic layers as presented, for example, in US2010304086A1, which can, however, make the production of the panes more difficult or limit their potential uses. US2003179455A1 discloses a two-layer antireflection coating for plastic parts that is supposed to reduce the visibility of fingerprints. The layer thicknesses are selected such that they correspond to half or to one-fourth the average wavelength in order to achieve suitable interference effects.

US20130129945A1 discloses a pane with a thermal radiation reflecting coating, for example, constructed, starting from the substrate, from a silicon nitride layer, a silicon oxide layer, an ITO layer, another silicon nitride layer, another silicon oxide layer, and a final titanium oxide layer. The coating is applied on an external glass surface and has self-cleaning properties as a result of the titanium oxide final layer. The visibility of fingerprints is outside the scope of US20130129945A1.

US20150146286A1 discloses a pane with a thermal radiation reflecting coating, constructed, starting from the substrate, from a silicon oxide layer, an ITO layer, a silicon nitride layer, and another silicon oxide layer. The coating is applied on the interior-side external glass surface. The visibility of fingerprints is outside the scope of US20150146286A1.

U.S. Pat. No. 6,416,194B discloses a mirror, comprising a substrate and a reflecting coating. The reflectance spectrum of the coating has a local maximum at 428 nm. A local minimum shifted to shorter wavelengths is not disclosed, but seems, based on extrapolation of the reflectance spectrum, to be between 175 nm and 260 nm.

The object of the present invention is to provide a further improved pane having an electrically conductive coating on an exposed surface, on which fingerprints are less clearly visible.

The object of the present invention is accomplished according to the invention by a pane having an electrically conductive coating in accordance with claim 1. Preferred embodiments are evident from the dependent claims.

The pane according to the invention comprises a substrate and an electrically conductive coating on an exposed surface of the substrate. The coating according to the invention includes at least one electrically conductive layer. In the context of the invention, the term “exposed surface” means a surface of the substrate that is accessible and has direct contact with the surrounding atmosphere such that the coating can be directly touched by an individual or, for example, can be contaminated by dirt, oils, or fats. The coating is sufficiently corrosion resistant to be used on an exposed surface.

Fingerprints consist of a mixture of different biological substances, in particular, fats and acids. According to values in the literature, a refractive index of approx. 1.3 to 1.6 can be assumed for fingerprints. The inventors found through measurements by white light interference microscopy (WLIM) that typical fingerprints have a thickness of a few nanometers up to several hundred nanometers. The invention is based on the knowledge that the visibility of fingerprints up to a thickness of a few hundred nanometers can be influenced by interference optics, which can in turn be adjusted through the design of the layer system forming the coating. Very thick fingerprints can, to be sure, be less influenced by interference optics; however, the overall optics of the pane are substantially improved if at least the fingerprints with a thickness of a few hundred nanometers, which make up the majority of all fingerprints, are less visible. The inventors surprisingly realized that a pane having an electrically conductive coating that is set such that it has a local minimum of reflectance in the range from 310 nm to 360 nm and a local maximum of reflectance in the range from 400 nm to 460 nm results in reduced visibility of typical fingerprints. The local minimum of reflectance is preferably in the range from 315 nm to 355 nm, particularly preferably from 320 nm to 350 nm. The local maximum of reflectance is preferably in the range from 415 nm to 450 nm. Said local extreme values are to be understood as as a minimum requirement and are not intended to rule out the fact that these are global extreme values. While in the case of the maximum of reflectance, at least outside the visible range, spectral ranges exist that have higher reflectance, it is also, however, conceivable that said local minimum of reflectance is the global minimum in the mathematical sense.

The term “reflectance” is used as defined in the DIN EN 410 standard. “Reflectance” always refers to the layer-side reflectance that is measured when the coated surface of the pane faces the light source and the detector. The values indicated for refractive indices are measured at a wavelength of 550 nm.

The coating according to the invention is, in a preferred embodiment, a thermal radiation reflecting coating. Such a coating is often also referred to as low-E coating, low emissivity coating, or emissivity reducing coating. Its function is to prevent irradiation of heat into the interior (IR portions of sunlight and, in particular, the thermal radiation of the pane itself) and also the emission of heat out of the interior. However, the coating can, in principle, also fulfill other functions when it is electrically contacted such that it is heated as a result of an electric current flow.

The pane according to the invention is preferably a window pane and is intended, in an opening, for example, of a vehicle or a building, to separate the interior from the external environment. The exposed surface on which the coating according to the invention is arranged is preferably the interior-side surface of the pane or of the substrate. In the context of the invention, the term “interior-side surface” means that surface that is intended to face the interior in the installed position of the pane. This is particularly advantageous in terms of the thermal comfort in the interior. With high outdoor temperatures and sunlight, the coating according to the invention can particularly effectively at least partially reflect the thermal radiation radiated by the entire pane in the direction of the interior. With low outdoor temperatures, the coating according to the invention can effectively reflect the thermal radiation emitted from the interior and thus reduce the effect of the cold pane as a heat sink. Customarily, the surfaces of a glazing are numbered from the outside to the inside such that the interior-side surface is referred to as “side 2” in the case of a single glazing, as “side 4” in the case of a double glazing (for example, laminated glass or insulating glazing units). However, the coating can, alternatively, also be arranged on the outside surface of the pane. It can be useful, in particular in the architectural sector, for example, as an anti-condensation coating on a window pane.

However, alternatively, the coating can also fulfill other functions, for example, as an electrically based capacitive or resistive sensor for tactile applications, such as touch screens or touch panels, which are naturally often soiled by fingerprints.

The coating is a sequence of thin layers (layer structure, layer stack). Whereas the electrical conductivity is ensured by the at least one electrically conductive layer, the optical properties, in particular transmittance and reflectivity, are significantly influenced by the other layers and can be selectively set by their design. So-called “antireflection layers”, which have a lower refractive index than the electrically conductive layer and are arranged above and below it, have a special influence in this context. In particular as a result of interference effects, these antireflection layers can increase transmittance through the pane and reduce reflectivity. The effect is, decisively, a function of refractive index and layer thickness. In an advantageous embodiment, the coating includes in each case at least one antireflection layer below and above the electrically conductive layer, with the antireflection layers having a lower refractive index than the electrically conductive layer, preferably a refractive index of at most 1.8, in particular of at most 1.6.

The coating according to the invention is transparent, thus does not appreciably restrict through-vision through the pane. The absorption of the coating is preferably from approx. 1% to approx. 20% in the visible spectral range. The term “visible spectral range” means the spectral range from 380 nm to 780 nm.

In the context of the invention, if a first layer is arranged “above” a second layer, this means that the first layer is farther from the substrate than the second layer is. In the context of the invention, if a first layer is arranged “below” a second layer, this means that the second layer is farther from the substrate than the first layer is. In the context of the invention, if a first layer is arranged above or below a second layer, this does not necessarily mean that the first and the second layer are in direct contact with one another. One or more additional layers can be arranged between the first and the second layer, unless this is explicitly ruled out.

The coating is typically applied full-surface on the substrate surface, possibly with the exception of a circumferential edge region and/or other locally limited regions that can serve, for example, for data transmission. The coated portion of the substrate surface is preferably at least 90%.

In the context of the invention, if a layer or other element “contains” at least one material, this includes the case that the layer is made of the material, which is, in principle, also preferable. The compounds described within the present invention, in particular oxides, nitrides, and carbides can, in principle, be stoichiometric, substoichiometric, or superstoichiometric, even though, for the sake of better understanding, the stoichiometric molecular formulae are cited.

For the reduced visibility of fingerprints or surface contamination, the occurrence according to the invention of the local extrema of reflectance is crucial. These properties can, in principle, be realized by a large number of embodiments of the layer structure of the coating, and the invention should not be limited to a specific layer structure. In principle, the extreme value distribution is determined by the selection of the layer sequence, the materials of the individual layers, and the respective layer thicknesses, wherein it can be influenced by a temperature treatment occurring after the coating. However, certain embodiments that are presented in the following have also proved to be particularly advantageous in terms of optimized material use and other optical properties.

The electrically conductive layer preferably has a refractive index of 1.7 to 2.3. In an advantageous embodiment, the electrically conductive layer contains at least one transparent, electrically conductive oxide (TCO, transparent conductive oxide). Such layers are corrosion resistant and can be used on exposed surfaces. The electrically conductive layer preferably contains indium tin oxide (ITO), which has proved itself particularly well, in particular due to low specific resistance and low scattering in terms of sheet resistance. However, the conductive layer can, alternatively, also contain, for example, mixed indium zinc oxide (IZO), gallium-doped tin oxide (GTO), fluorine-doped tin oxide (SnO₂:F), or antimony-doped tin oxide (SnO₂:Sb).

The thickness of the electrically conductive layer is preferably from 50 nm to 130 nm, particularly preferably from 60 nm to 100 nm, for example, from 65 nm to 80 nm. With this, particularly good results are achieved in terms of electrical conductivity with sufficient optical transparency at the same time.

In an advantageous embodiment, the coating includes a dielectric lower antireflection layer that is arranged below the electrically conductive layer. The refractive index of the lower antireflection layer is preferably at most 1.8, particularly preferably from 1.3 to 1.8.

The thickness of the lower antireflection layer is preferably from 5 nm to 50 nm, more preferably from 10 nm to 30 nm, for example, from 10 nm to 20 nm.

In an advantageous embodiment, the coating includes a dielectric upper antireflection layer that is arranged above the electrically conductive layer. The refractive index of the upper antireflection layer is preferably at most 1.8, particularly preferably from 1.3 to 1.8. The thickness of the upper antireflection layer is preferably from 10 nm to 100 nm, particularly preferably from 30 nm to 70 nm, for example, from 45 nm to 55 nm.

In a particularly advantageous embodiment, the coating has both a lower antireflection layer below the electrically conductive layer and an upper antireflection layer above the electrically conductive layer.

The antireflection layers bring about, in particular, advantageous optical properties of the pane. They reduce the reflectance and thus increase the transparency of the pane and ensure a neutral color impression. The antireflection layers preferably contain an oxide or fluoride, particularly preferably silicon oxide, aluminum oxide, magnesium fluoride, or calcium fluoride. The silicon oxide can be doped and is preferably doped with aluminum (SiO₂:Al), with boron (SiO₂:B), with titanium (SiO₂:Ti), or with zirconium (SiO₂:Zr). However, the layers can, alternatively, also contain, for example, aluminum oxide (Al₂O₃).

In a particularly advantageous embodiment, the upper antireflection layer is the uppermost layer of the coating. It thus has the greatest distance from the substrate surface and is the final layer of the layer stack, which is exposed and also accessible and touchable by individuals. In this case, the optical properties of the layer stack are optimal in terms of reduced visibility of fingerprints. Additional layers above the antireflection layer, in particular with a higher refractive index than the antireflection layer, would change the optical properties and could reduce the desired effect.

It has been shown that the oxygen content of the electrically conductive layer, in particular when this is based on a TCO, has a significant influence on its properties, in particular on transparency and conductivity. The production of the pane typically includes a temperature treatment, for example, a thermal tempering process, wherein oxygen can diffuse to the conductive layer and oxidize it. In an advantageous embodiment, the coating between the electrically conductive layer and the upper antireflection layer includes a dielectric barrier layer for regulating oxygen diffusion having a refractive index of at least 1.9. The barrier layer serves to adjust the supply of oxygen to an optimum level. Particularly good results are obtained when the refractive index of the barrier layer is from 1.9 to 2.5.

The dielectric barrier layer for regulating oxygen diffusion contains at least a metal, a nitride, or a carbide. The barrier layer can contain, for example, titanium, chromium, nickel, zirconium, hafnium, niobium, tantalum, or tungsten or a nitride or carbide of tungsten, niobium, tantalum, zirconium, hafnium, chromium, titanium, silicon or aluminum. In a preferred embodiment, the barrier layer contains silicon nitride (Si₃N₄) or silicon carbide, in particular silicon nitride (Si₃N₄), with which particularly good results are obtained. The silicon nitride can be doped and is, in a preferred further development, doped with aluminum (Si₃N₄:Al), with zirconium (Si₃N₄:Zr), with titanium (Si₃N₄:Ti), or with boron (Si₃N₄:B). In a temperature treatment after application of the coating according to the invention, the silicon nitride can be partially oxidized. Then, after the temperature treatment, a barrier layer deposited as Si₃N₄ contains SiₓN_{y}O_{z}, wherein the oxygen content is typically from 0 atom-% to 35 atom-%.

The thickness of the barrier layer is preferably from 5 nm to 20 nm, particularly preferably from 7 nm to 12 nm, for example, from 8 nm to 10 nm. Thus, the oxygen content of the conductive layer is particularly advantageously regulated. The thickness of the barrier layer is selected with regard to oxygen diffusion, less with regard to optical properties of the pane. However, it has been shown that barrier layers with thicknesses in the range indicated are compatible with the coating according to the invention and its optical requirements.

In an advantageous embodiment, the coating includes, below the electrically conductive layer, and, optionally, below the lower antireflection layer, a dielectric blocking layer against alkali diffusion. The blocking layer reduces or prevents the diffusion of alkali ions out of the glass substrate into the layer system. Alkali ions can adversely affect the properties of the coating. Furthermore, the blocking layer, in interaction with the lower antireflection layer, contributes advantageously to the setting of the optics of the coating structure as a whole. The refractive index of the blocking layer is preferably at least 1.9. Particularly good results are obtained when the refractive index of the blocking layer is from 1.9 to 2.5. The blocking layer preferably contains an oxide, a nitride, or a carbide, preferably of tungsten, chromium, niobium, tantalum, zirconium, hafnium, titanium, silicon, or aluminum. for example, oxides such as WO₃, Nb₂O₅, Bi_{O}O₃, TiO₂, Ta₂O₅, YO₃, ZrO₂, HfO₂ SnO₂, or ZnSnOₓ, or nitrides such as AlN, TiN, TaN, ZrN, or NbN. The blocking layer particularly preferably contains silicon nitride (Si₃N₄), with which particularly good results are obtained. The silicon nitride can be doped and is, in a preferred further development, doped with aluminum (Si₃N₄:Al), with titanium (Si₃N₄:Ti), with zirconium (Si₃N₄:Zr), or with boron (Si₃N₄:B). The thickness of the blocking layer is preferably from 10 nm to 50 nm, particularly preferably from 20 nm to 40 nm, for example, from 25 nm to 35 nm. The blocking layer is preferably the bottommost layer of the layer stack, i.e., has direct contact with the substrate surface, where it can have optimum effect.

The coating consists, in an advantageous embodiment, exclusively of layers having a refractive index of at least 1.9 or of at most 1.8, preferably at most 1.6. In a particularly preferred embodiment, the coating consists only of the layers described and contains no further layers. The coating then consists of the following layers in the order indicated, starting from the substrate surface:
blocking layer against alkali diffusion
lower antireflection layer
electrically conductive layer
barrier layer for regulating oxygen diffusion
upper antireflection layer.

The interior-side emissivity of the pane according to the invention is preferably less than or equal to 45%, particularly preferably less than or equal to 35%, most particularly preferably less than or equal to 30%. Here, the term “interior-side emissivity” refers to the measurement that indicates how much thermal radiation the pane gives off in the installed position compared to an ideal thermal radiator (a black body) in an interior, for example, of a building or of a vehicle. In the context of the invention, “emissivity” means the total normal emissivity at 283 K per the standard EN 12898.

The sheet resistance of the coating according to the invention is preferably from 10 ohm/square to 100 ohm/square, particularly preferably from 15 ohm/square to 35 ohm/square.

The substrate is made of an electrically insulating, in particular a rigid material, preferably of glass or plastic. The substrate contains, in a preferred embodiment, soda lime glass, but can, in principle, also contain other types of glass, for example, borosilicate glass, or quartz glass. The substrate contains, in another preferred embodiment, polycarbonate (PC) or polymethyl methacrylate (PMMA). The substrate can be as transparent as possible or also tinted or colored. The substrate preferably has a thickness of 0.1 mm to 20 mm, typically of 2 mm to 5 mm. The substrate can be flat or curved. In a particularly advantageous embodiment, the substrate is a thermally tempered glass pane.

The invention also includes a method for producing a pane having an electrically conductive coating, wherein

(a) an electrically conductive coating that comprises at least one electrically conductive layer is applied on an exposed surface of a substrate; and

(b) the substrate with the coating is subjected to a temperature treatment at at least 100° C., whereafter the pane has a local minimum of reflectance in the range from 310 nm to 360 nm, in particular 320 nm to 350 nm and a local maximum of reflectance in the range from 400 nm to 460 nm.

The pane is subjected, after application of the heatable coating to a temperature treatment, which, in particular, improves the crystallinity of the functional layer. The temperature treatment is preferably done at at least 300° C. In particular, the temperature treatment reduces the sheet resistance of the coating. Moreover, the optical properties of the pane are significantly improved, in particular transmittance is increased.

The temperature treatment can be done in various ways, for example, by heating the pane using a furnace or a radiant heater. Alternatively, the temperature treatment can also be done by irradiation with light, for example, with a lamp or a laser as the light source.

In an advantageous embodiment, the temperature treatment is done, in the case of a glass substrate, within a thermal tempering process. The heated substrate is subjected to a stream of air, rapidly cooling the substrate. Compressive stresses develop at the surface of the pane and tensile stresses develop in the core of the pane. The characteristic distribution of stresses increases the breaking strength of the glass panes. A bending process can also precede the tempering.

The individual layers of the heatable coating are deposited by methods known per se, preferably by magnetron-enhanced cathodic sputtering. This is particularly advantageous in terms of a simple, quick, economical, and uniform coating of the substrate. The cathodic sputtering is done in a protective gas atmosphere, for example, of argon, or in a reactive gas atmosphere, for example, by addition of oxygen or nitrogen. The layers can, however, also be applied using other methods known to the person skilled in the art, for example, by vapor deposition or chemical vapour deposition (CVD), by atomic layer deposition (ALD), by plasma-enhanced chemical vapor deposition (PECVD), or using wet chemical methods.

In an advantageous embodiment, a blocking layer against alkali diffusion is applied before the electrically conductive layer. In an advantageous embodiment, a lower reflection layer is applied before the electrically conductive layer and, optionally, after the blocking layer. In an advantageous embodiment, a barrier layer for regulating oxygen diffusion is applied after the conductive layer. In an advantageous embodiment, an upper antireflection layer is applied after the conductive layer and, optionally, after the barrier layer.

For the selection of suitable materials and layer thicknesses to realize the reflection spectrum according to the invention, the person skilled in the art can, for example, use simulations customary in the art.

The invention also includes the use of a pane according to the invention in buildings, in electrical or electronic equipment, or in means of transportation for travel on land, in the air, or on water. The pane is preferably used as a window pane, for example, as a building window pane or as a roof panel, side window, rear window, or windshield of a vehicle, in particular of a motor vehicle. Alternatively, the pane is preferred as an electrically based capacitive or resistive sensor for tactile applications, for example, as a touch screen or a touch panel.

In the following, the invention is explained in detail with reference to drawings and exemplary embodiments. The drawings are a schematic representation and are not to scale. The drawings in no way restrict the invention.

They depict:

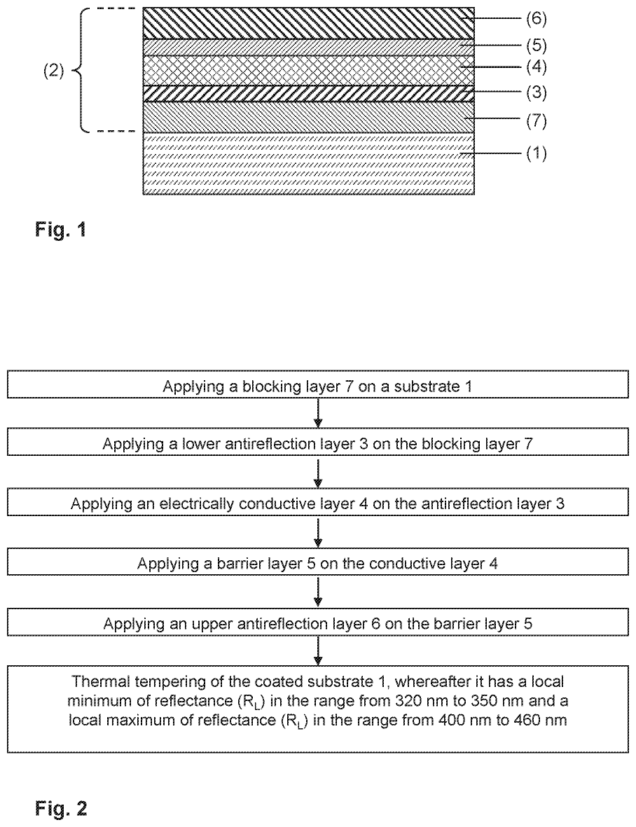

FIG. 1 a cross-section through an embodiment of the pane according to the invention having a heatable coating,

FIG. 2 a flowchart of an embodiment of the method according to the invention,

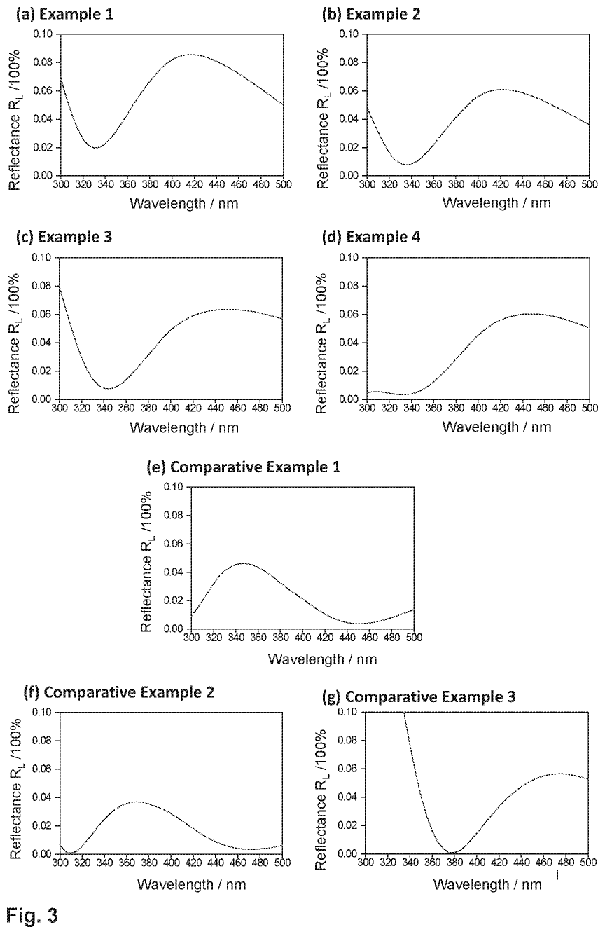

FIG. 3 a diagram of reflectance R_{L} as a function of wavelength for two examples to according to the invention and two comparative examples, and

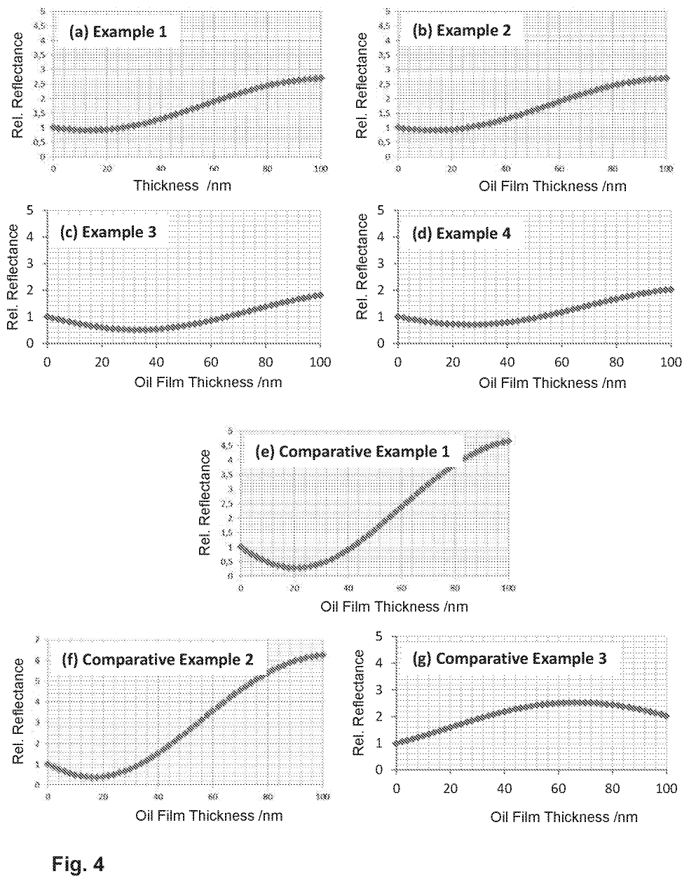

FIG. 4 simulation results of the relative reflectance as a function of the thickness of an oil film deposited on the on the coating 2 for the examples and comparative examples of FIG. 3.

FIG. 1 depicts a cross-section through an embodiment of the pane according to the invention with the substrate 1 and the electrically conductive coating 2. The substrate 1 is, for example, a glass pane made of tinted soda lime glass and has a thickness of 2.1 mm. The coating 2 is a thermal radiation reflecting coating (low-E coating). The pane is intended, for example, as a roof panel of a motor vehicle. Roof panels are typically implemented as composite glass panes, wherein the substrate 1 is joined by its surface facing away from the coating 2 to an outer pane (not shown) via a thermoplastic film. The substrate 1 forms the inner pane of the composite glass, wherein the coating 2 is applied on the exposed interior-side surface that can be touched directly by the vehicle occupants. As a result, fingerprints can accumulate on the coating 2. The optical properties of the coating 2 are optimized such that fingerprints are less highly visible than with conventional coatings. This is accomplished according to the invention in that the coating is designed such that the pane has a local minimum of reflectance R_{L} in the range from 320 nm to 350 nm and a local maximum of reflectance R_{L} in the range from 400 nm to 460 nm. Surprisingly, fingerprints are less noticeable under this condition.

The coating 2 is a sequence of thin layers, comprising, starting from the substrate 1, the following individual layers: a blocking layer 7 against alkali diffusion, a lower antireflection layer 3, an electrically conductive layer 4, a barrier layer 5 for regulating the oxygen diffusion layer 5, and an upper antireflection layer 6. The materials and layer thicknesses are summarized in Table 1. The individual layers of the coating 2 were deposited by magnetron-enhanced cathodic sputtering.

TABLE 1

| | Reference | | | Thick- |
|---|---|---|---|---|
| Layer | No. | | Material | ness |
| Upper antireflection layer | 6 | 2 | SiO₂:Al | 50 nm |
| Barrier layer | 5 | | Si₃N₄:Al | 9 nm |
| Electrically conductive layer | 4 | | ITO | 70 nm |
| Lower antireflection layer | 3 | | SiO₂:Al | 17 nm |
| Blocking layer | 7 | | Si₃N₄:Al | 30 nm |
| Substrate | 1 | | Soda lime glass | 2.1 mm |

FIG. 2 shows a flowchart of an exemplary embodiment of the production method according to the invention.

lo FIG. 3 shows diagrams of the reflectance R_{L} for four examples according to the invention and three comparative examples. The materials and layer thicknesses of the coating 2 of examples 1-4 are summarized in Table 2; those of the comparative examples 1-3, in Table 3. In the examples 1-4, the pane comprised a substrate 1 of tinted soda lime glass with light transmittance T_{L} of approx. 25% and the coating 2, which, starting from the substrate 1, was constructed from a blocking layer 7, a lower antireflection layer 3, an electrically conductive layer 4, a barrier layer 5, and an upper antireflection layer 6. The layers were formed from the same materials, with the coatings 2 of the examples 1-4 differing in the layer thicknesses. However, for the examples 1-4 according to the invention, the coating 2 was, in contrast to the comparative examples, in each case adjusted such that the pane had a local minimum of reflectance R_{L} in the range from 320 nm to 350 nm and a local maximum of reflectance R_{L} in the range from 400 nm to 460 nm, as can be seen in the figure. All panes had been subjected to a temperature treatment at approx. 650° C. within a glass bending process.

TABLE 2

| | | Thickness | | | |
|---|---|---|---|---|---|
| Layer | Material | Example 1 | Example 2 | Example 3 | Example 4 |
| 6 | SiO₂ | 50 nm | 55 nm | 50 nm | 50 nm |
| 5 | Si₃N₄ | 9 nm | 9 nm | 9 nm | 9 nm |
| 4 | ITO | 70 nm | 80 nm | 70 nm | 120 nm |
| 3 | SiO₂ | 17 nm | 10 nm | 30 nm | 15 nm |
| 7 | Si₃N₄ | 30 nm | 25 nm | 20 nm | 10 nm |
| 1 | Glass | 2.1 mm | 2.1 mm | 2.1 mm | 2.1 mm |

TABLE 3

| | | Thickness | | |
|---|---|---|---|---|
| Layer | Material | Comp. Ex, 1 | Comp. Ex, 2 | Comp. Ex, 3 |
| — | TiO₂ | — | — | 5 nm |
| 6 | SiO₂ | 70 nm | 70 nm | 50 nm |
| 5 | Si₃N₄ | 9 nm | 9 nm | 9 nm |
| 4 | ITO | 70 nm | 80 nm | 70 nm |
| 3 | SIO₂ | 30 nm | 30 nm | 17 nm |
| 7 | Si₃N₄ | — | — | 30 nm |
| 1 | Glass | 2.1 mm | 2.1 mm | 2.1 mm |

The comparative examples 1 and 2 basically differed from the examples according to the invention through the absence of the blocking layer 7, resulting in significant changes in the reflection spectrum, such that the local extrema did not occur according to the invention. In the comparative example 3, yet another layer TiO₂ was applied above the upper antireflection layer 6, as it is used, for example, as a photocatalytic layer in self-cleaning coatings. The upper antireflection layer 6 was, consequently, not the uppermost layer of the coating 2.

In contrast to the examples 1-4 according to the invention, the local extrema of the reflectance R_{L} with the comparative examples 1-3 were not positioned in the spectrum according to the invention. The occurrence of the local extrema is summarized in Table 4. The values of reflectance R_{L} presented were determined through simulations using CODE software.

TABLE 4

| | Minimum R_{L} | Maximum R_{L} |
|---|---|---|
| Ex. 1 | 335 nm | 420 nm |
| Ex. 2 | 335 nm | 425 nm |
| Ex. 3 | 345 nm | 450 nm |
| Ex. 4 | 335 nm | 450 nm |
| Comp. Ex. 1 | <300 nm | 350 nm |
| Comp. Ex. 2 | 305 nm | 370 nm |
| Comp. Ex. 3 | 375 nm | 425 nm |

To take into account the influence of a fingerprint, the simulations were expanded by an oil film (refractive index 1.58) on the coating 2. The relative reflectance for the examples and comparative examples was then calculated as a quotient (reflectance of the pane with oil film)/(reflectance of the pane without oil film). The result is presented in FIG. 4 as a function of the thickness of the oil film.

In the examples 1 and 2 according to the invention, the relative reflectance for thin oil films up to approx. 20 nm is approx. 1; i.e., the reflectance is hardly changed by the oil film. With thicker oil films, the reflectance increases slowly to a value of approx. 2.5 with an oil film of 100 nm. In the examples 3 and 4, the relative reflectance decreases slightly at the beginning and increases just as slowly starting at approx. 30 nm oil film thickness.

In the comparative examples 1 and 2, a significantly different behavior is seen. Already with thin oil films, the reflection changes significantly and the relative reflectance initially decreases sharply. It then also increases starting at an oil film thickness of approx. 20 nm, but significantly more sharply than in the examples according to the invention. In the case of comparative example 3, a much sharper increase of the relative reflectance can already be seen with very thin oil films.

From the examples and comparative examples, it can clearly be seen that the presence of an oil film results, in the case of the coatings 2 according to the invention, in a significantly less pronounced change in the reflectance than in the case of coatings not according to the invention. Fingerprints, which are essentially fat deposits and are optically quite similar to an oil film, are thus significantly less visible due to the lower contrast. The fact that the visibility of fingerprints can be reduced by simply optimizing the optical properties of the coating was unexpected and surprising for the person skilled in the art.

Additional examples according to the invention (Ex. 6-12) and comparative examples (Comp. Ex. 4-12) are presented in Table 5. In each case, the thicknesses of the individual layers are indicated, from left to right starting from the substrate 1 (tinted soda lime glass). The spectral position of the local extrema of the reflectance R_{L} is summarized in Table 6. All panes were again subjected to a temperature treatment at approx. 650° C. in a glass bending process.

TABLE 5

| | Layer | | | | | | |
|---|---|---|---|---|---|---|---|
| | 1 | 7 | 3 | 4 | 5 | 6 | |
| Material | Glass | Si₃N₄ | SiO₂ | ITO | Si₃N₄ | SiO₂ | TiO₂ |
| Ex. 6 | 2.1 mm | 30 nm | 30 nm | 75 nm | 9 nm | 30 nm | — |
| Ex. 7 | 2.1 mm | 40 nm | 10 nm | 70 nm | 9 nm | 50 nm | — |
| Ex. 8 | 2.1 mm | 15 nm | 20 nm | 90 nm | 9 nm | 50 nm | — |
| Ex. 9 | 2.1 mm | 20 nm | 15 nm | 100 nm | 9 nm | 45 nm | — |
| Ex. 10 | 2.1 mm | 25 nm | 20 nm | 60 nm | 9 nm | 50 nm | — |
| Ex, 11 | 2.1 mm | 25 nm | 25 nm | 50 nm | 9 nm | 60 nm | — |
| Ex. 12 | 2.1 mm | 20 nm | 10 nm | 70 nm | 9 nm | 70 nm | — |
| Comp. | 2.1 mm | 20 nm | 10 nm | 70 nm | 9 nm | 70 nm | 5 nm |
| Ex. 4 | | | | | | | |
| Comp. | 2.1 mm | — | 30 nm | 70 nm | 9 nm | 50 nm | — |
| Ex. 5 | | | | | | | |
| Comp. | 2.1 mm | 0 nm | 30 nm | 70 nm | 9 nm | 50 nm | 5 nm |
| Ex. 6 | | | | | | | |
| Comp. | 2.1 mm | 20 nm | 15 nm | 100 nm | 9 nm | 45 nm | 5 nm |
| Ex. 7 | | | | | | | |
| Comp. | 2.1 mm | — | 30 nm | 100 nm | 9 nm | 55 nm | — |
| Ex. 8 | | | | | | | |
| Comp. | 2.1 mm | 10 nm | 15 nm | 120 nm | 9 nm | 50 nm | 5 nm |
| Ex. 9 | | | | | | | |
| Comp. | 2.1 mm | — | 30 nm | 120 nm | 9 nm | 75 nm | — |
| Ex. 10 | | | | | | | |
| Comp, | 2.1 mm | 25 nm | 20 nm | 60 nm | 9 nm | 50 nm | 5 nm |
| Ex. 11 | | | | | | | |
| Comp. | 2.1 mm | — | 30 nm | 50 nm | 9 nm | 50 nm | — |
| Ex. 12 | | | | | | | |

TABLE 6

| | Minimum R_{L} | Maximum R_{L} |
|---|---|---|
| Ex. 6 | 330 nm | 425 nm |
| Ex. 7 | 330 nm | 415 nm |
| Ex. 8 | 340 nm | 450 nm |
| Ex. 9 | 345 nm | 455 nm |
| Ex. 10 | 320 nm | 400 nm |
| Ex. 11 | 345 nm | 410 nm |
| Ex. 12 | 355 nm | 430 nm |
| Comp. Ex. 4 | 385 nm | 455 nm |
| Comp. Ex. 5 | 385 nm | 610 nm |
| Comp. Ex. 6 | 300 nm | 370 nm |
| Comp. Ex. 7 | 385 nm | 500 nm |
| Comp. Ex. 8 | 310 nm | 375 nm |
| Comp. Ex. 9 | 390 nm | 490 nm |
| Comp. Ex. 10 | 380 nm | 460 nm |
| Comp. Ex. 11 | 365 nm | 455 nm |
| Comp. Ex. 12 | 350 nm | 560 nm |

In reality, fingerprints have a wide range of thicknesses, including even those with layer thicknesses greater than 1 μm. In the case of such thick deposits, the effects of interference optics no longer play a decisive role such that visibility can no longer be significantly influenced by the optical properties of the coating 2. However, for the majority of fingerprints in the range up to approx. 100 nanometers, visibility can be significantly reduced. This significantly improves the overall impression of the pane.

### LIST OF REFERENCE CHARACTERS

(1) substrate

(2) heatable coating

(3) lower antireflection layer

(4) electrically conductive layer

(5) barrier layer for regulating oxygen diffusion

(6) upper antireflection layer

(7) blocking layer against alkali diffusion

R_{L} reflectance (per DIN EN410)

1. Pane having an electrically conductive coating, comprising a substrate and an electrically conductive coating on an exposed surface of the substrate, which electrically conductive coating, starting from the substrate, at least comprises
a blocking layer against alkali diffusion having a refractive index of at least 1.9,
a dielectric lower antireflection layer having a refractive index of 1.3 to 1.8,
an electrically conductive layer,
a dielectric barrier layer for regulating oxygen diffusion having a refractive index of at least 1.9, and
a dielectric upper antireflection layer having a refractive index of 1.3 to 1.8, wherein the pane has a local minimum of reflectance (R_{L}) in the range from 310 nm to 360 nm and a local maximum of reflectance (R_{L}) in the range from 400 nm to 460 nm.

2. The pane according to claim 1, wherein the electrically conductive layer contains a transparent conductive oxide.

3. The pane according to claim 1, wherein the electrically conductive layer has a thickness of 50 nm to 150 nm.

4. The pane according to claim 1, wherein the lower antireflection layer and/or the upper antireflection layer contains at least one oxide.

5. The pane according to claim 1, wherein the lower antireflection layer has a thickness of 5 nm to 50 nm, and wherein the upper antireflection layer has a thickness of 10 nm to 100 nm .

6. The pane according to claim 1, wherein the upper antireflection layer is the uppermost layer of the coating.

7. The pane according to claim 1, wherein the barrier layer has a refractive index of 1.9 to 2.5.

8. The pane according to claim 1, wherein the barrier layer contains a metal, a nitride, or a carbide.

9. The pane according to claim 1, wherein the barrier layer has a thickness of 5 nm to 20 nm.

10. The pane according to claim 1, wherein the blocking layer has a refractive index of 1.9 to 2.5.

11. The pane according to claim 1, wherein the blocking layer contains silicon nitride, which is optionally aluminum-doped, zirconium-doped, titanium-doped, or boron-doped silicon nitride.

12. The pane according to claim 1, wherein the blocking layer has a thickness of 10 nm to 50 nm.

13. Method for producing a pane having an electrically conductive coating, comprising:
(a) applying an electrically conductive coating on an exposed surface of a substrate, which electrically conductive coating, starting from the substrate, at least comprises
a blocking layer against alkali diffusion having a refractive index of at least 1.9,
a dielectric lower antireflection layer having a refractive index of 1.3 to 1.8,
an electrically conductive layer,
a dielectric barrier layer for regulating oxygen diffusion having a refractive index of at least 1.9, and
a dielectric upper antireflection layer having a refractive index of 1.3 to 1.8; and
(b) subjecting the substrate with the coating to a temperature treatment at at least 100° C., whereafter the pane has a local minimum of reflectance (R_{L}) in the range from 310 nm to 360 nm and a local maximum of reflectance (R_{L}) in the range from 400 nm to 460 nm.

14. A method comprising utilizing a pane according to claim 1 in buildings, in electrical or electronic equipment, or in means of transportation for travel on land, in the air, or on water or as a capacitive or resistive sensor for tactile applications.

15. The pane according to claim 2, wherein the transparent conductive oxide is indium tin oxide (ITO).

16. The pane according to claim 3, wherein the electrically conductive layer has a thickness of 60 nm to 100 nm.

17. The pane according to claim 4, wherein the at least one oxide is silicon oxide, which is optionally aluminum-doped, zirconium-doped, titanium-doped, or boron-doped.

18. The pane according to claim 5, wherein the lower antireflection layer has a thickness of 10 nm to 30 nm and wherein the upper antireflection layer has a thickness of 30 nm to 70 nm.

19. The pane according to claim 8, wherein the barrier layer contains silicon nitride or silicon carbide.

20. The pane according to claim 9, wherein the barrier layer has a thickness of 7 nm to 12 nm.

21. The pane according to claim 12, wherein the blocking layer has a thickness of 20 nm to 40 nm.

22. The method according to claim 14, wherein the pane is a window pane, a building window pane or a roof panel, a side window, a rear window, a windshield of a vehicle, a touch screen or a touch panel.
